(19) United States
(12) Patent Application Publication
(10) Pub. No.: US 2016/0355728 A1
(43) Pub. Date: Dec. 8, 2016

(54) Proppant material and its use in lithological displacement at trona-shale interface

(71) Applicant: SOLVAY SA, Brussels (BE)

(72) Inventors: Joseph A. VENDETTI, Green River, WY (US); Ronald O. HUGHES, Green River, WY (US); Hervé CUCHE, Waterloo (BE); Beatrice C. ORTEGO, Katy, TX (US)

(21) Appl. No.: 14/579,257

(22) Filed: Dec. 22, 2014

Related U.S. Application Data
(60) Provisional application No. 61/919,868, filed on Dec. 23, 2013.

(51) Int. Cl. C09K 8/80; E21B 43/267

(52) U.S. Cl. CPC C09K 8/805; E21B 43/267

(57) ABSTRACT

A proppant material and its use for lithological displacement of an underground evaporite mineral stratum from a non-evaporite stratum, particularly of a trona stratum from a shale stratum. A lifting hydraulic pressure greater than the overburden pressure is applied at a weak strata interface, resulting in separating the strata and forming an interface gap with a mineral free-surface. The proppant is placed inside such gap as the gap is being formed or thereafter. The proppant may comprise tailings and/or particles containing an alkali compound, such as sodium hydroxide, trona, or soda ash particles. The proppant may comprise slow-water dissolving coated particles, particularly a slow-dissolving polymeric coating over a water-soluble alkali core. After propping the interface gap, the mineral from the formed mineral free-surface is dissolved by a production solvent, thereby enlarging the gap and forming a mineral cavity. The proppant preferably dissolves or degrades in the production solvent.

### CROSS-REFERENCE TO RELATED APPLICATIONS

This application claims the priority benefit to U.S. provisional application No. 61/919,868 filed Dec. 23, 2013, this application being incorporated herein by reference in its entirety for all purposes.

### TECHNICAL FIELD OF THE INVENTION

This invention relates to solid proppant material, a lithological displacement fluid comprising such solid proppant material, and its use in a lithological displacement of an evaporite mineral when injected at a parting interface between such evaporite mineral and a non-evaporite mineral. Particular embodiments refer to solid proppant material and its use for lithological displacement of a trona stratum when injected at a trona/shale weak interface.

### BACKGROUND OF THE INVENTION

Sodium carbonate (Na₂CO₃), or soda ash, is one of the largest volume alkali commodities made world wide with a total production in 2008 of 48 million tons. Sodium carbonate finds major use in the glass, chemicals, detergents, paper industries, and also in the sodium bicarbonate production industry. The main processes for sodium carbonate production are the Solvay ammonia synthetic process, the ammonium chloride process, and the trona-based processes.

Crude trona is a mineral that may contain up to 99% sodium sesquicarbonate (generally about 70-99%). Sodium sesquicarbonate is a sodium carbonate sodium bicarbonate double salt having the formula (Na₂CO₃.NaHCO₃.2H₂O) and which contains 46.90 wt. % Na₂CO₃, 37.17 wt. % NaHCO₃ and 15.93 wt. % H₂O. Crude trona also contains, in lesser amounts, sodium chloride (NaCl), sodium sulfate (Na₂SO₄), organic matter, and insolubles such as clay and shales. A typical analysis of the trona ore mined in Green River is shown in TABLE 1.

Trona-based soda ash is obtained from trona ore deposits in the U.S. (southwestern Wyoming in Green River, in California near Searles Lake and Owens Lake), Turkey, China, and Kenya (at Lake Magadi) by underground mechanical mining techniques, by solution mining, or lake waters processing. A variety of different systems and mechanical mining techniques (such as longwall mining, shortwall mining, room-and-pillar mining, or various combinations) exist. Although any of these various mining techniques may be employed to mine trona ore, when a mechanical mining technique is used, nowadays it is preferably longwall mining. In 2007, trona-based sodium carbonate from Wyoming comprised about 90% of the total U.S. soda ash production.

TABLE 1

| Constituent | Weight Percent |
|---|---|
| Na₂CO₃ | 43.4 |
| NaHCO₃ | 34.4 |
| H₂O (crystalline and free moisture) | 15.4 |
| NaCl | 0.01 |
| Na₂SO₄ | 0.01 |
| Fe₂O₃ | 0.14 |
| Insolubles | 6.3 |
| Organics | 0.3 |

To recover valuable alkali products, the so-called ‘monohydrate’ commercial process is frequently used to produce soda ash from trona. When the trona is mechanically mined, crushed trona ore is calcined (i.e., heated) to convert sodium bicarbonate into sodium carbonate, drive off water of crystallization and form crude soda ash. The crude soda ash is then dissolved in water and the insoluble material is separated from the resulting solution. A clear solution of sodium carbonate is fed to a monohydrate crystallizer, e.g., a high temperature evaporator system generally having one or more effects (sometimes called ‘evaporator-crystallizer’), where some of the water is evaporated and some of the sodium carbonate forms into sodium carbonate monohydrate crystals (Na₂CO₃.H₂O). The sodium carbonate monohydrate crystals are removed from the mother liquor and then dried to convert the crystals to dense soda ash. Most of the mother liquor is recycled back to the evaporator system for additional processing into sodium carbonate monohydrate crystals.

The Wyoming trona deposits are evaporites and form various substantially horizontal layers (or beds). The major deposits consists of 25 near horizontal beds varying from 4 feet (1.2 m) to about 36 feet (11 m) in thickness and separated by layers of shales. Depths range from 400 ft (120 m) to 3,300 ft (1,000 m). These deposits contain from about 88% to 95% sesquicarbonate, with the impurities being mainly dolomite and calcite-rich shales and shortite. Some regions of the basin contain soluble impurities, most notably halite (NaCl). These extend for about 1,000 square miles (about 2,600 km²), and it is estimated that they contain over 75 billions tons of soda ash equivalent, thus providing reserves adequate for reasonably foreseeable future needs.

The large deposits of mineral trona in the Green River Basin in southwestern Wyoming have been mined since the late 1940's. However, only a few beds have been exploited by five separate mining operations over the intervening period.

For mechanical mining, trona mine operators have used the main trona bed No. 17 in the Green River Basin, because it is thick (averaging a thickness of about 8 feet (2.4 m) to about 11 feet (3.3 m)), has very good ore quality and is not too deep being located from approximately 1,200 feet (about 365 m) to approximately 1,600 feet (about 488 m) below ground surface. This main bed is located below substantially horizontal layers of sandstones, siltstones and mainly unconsolidated shales. In particular, within about 400 feet (about 122 m) above the main trona bed are layers of mainly weak, laminated green-grey shales and oil shale, interbedded with bands of trona from about 4 feet (about 1.2 m) to about 5 feet thick (about 1.5 m). Immediately below the main trona bed lie substantially horizontal layers of somewhat plastic oil shale, also interbedded with bands of trona. Both overlying and underlying shale layers contain methane gas.

The comparative tensile strengths, in pounds per square inch (psi) or kilopascals (kPa), of trona and shale in average values are substantially as follows:
Shale: 70-140 psi (482-965 kPa)
Trona: 290-560 psi (2,000-3,861 kPa)

Both the immediately overlying shale layer and the immediately underlying shale layer are substantially weaker than the main trona bed. Accordingly, recovery of trona from this main bed essentially comprises removing the only strong layer within its immediate vicinity.

All mechanical mining techniques require miners and heavy machinery to be underground to dig out and convey the ore to the surface, including sinking shafts of about 800-2,000 feet (about 240-610 meters) in depth. The cost of the mechanical mining methods for trona is high, representing as much as 40 percent of the production costs for soda ash. Furthermore, recovering trona by these methods becomes more difficult as the thickest beds (more readily accessible reserves) of trona deposits with a high quality (less contaminants) were exploited first and are now being depleted. As a result, the production of sodium carbonate using the combination of mechanical mining techniques followed by the monohydrate process is becoming more expensive, as the higher quality trona deposits become depleted and labor and energy costs increase. Furthermore, development of new reserves is expensive, requiring a capital investment of as much as hundreds of million dollars to sink new mining shafts and to install related mining and safety (ventilation) equipment.

Additionally, because some shale is also removed during mechanical mining, this extracted shale must be transported along with the trona ore to the surface refinery, removed from the product stream, and transported back into the mine, or a surface waste pond. These insoluble contaminants not only cost a great deal of money to mine, remove, and handle, they provide very little value back to the mine and refinery operator.

Recognizing the economic and physical limitations of underground mechanical mining techniques, solution mining of trona has been long touted as an attractive alternative with the first patent U.S. Pat. No. 2,388,009 entitled “Solution Mining of Trona” issued to Pike in 1945.

In its simplest form, solution mining of trona is carried out by contacting trona ore with a solvent such as water or an aqueous solution to dissolve the ore and form a liquor (also termed ‘brine’) containing dissolved sodium values. For contact, the water or aqueous solution is injected into a cavity of the underground formation, to allow the solution to dissolve as much water-soluble trona ore as possible, and then the resulting brine is extracted to the surface. A portion of the brine can be used as feed stock to one or more processes to manufacture one or more sodium-based products, while another brine portion may be re-injected for additional contact with trona.

A solution mining approach would allow the exploitation of trona from less desirable beds (thin beds, poor quality beds, and/or deeper beds) which are currently less economically viable for mechanical mining, without the negative impact of increased mining hazards and increased costs. Solution mining of trona could indeed reduce or eliminate the costs of underground mining including sinking costly mining shafts and employing miners, hoisting, crushing, calcining, dissolving, clarification, solid/liquid/vapor waste handling and environmental compliance.

However, the solution mining process for a sodium (bi)carbonate-containing trona ore is not as simple as it may seem because of the complex solubility relationships of sodium sesquicarbonate (a double salt), the main component in trona ore. A complicating factor in dissolving in situ this double-salt ore is that sodium carbonate and sodium bicarbonate have different solubilities and dissolving rates in water. These incongruent solubilities of sodium carbonate and sodium bicarbonate can cause sodium bicarbonate “blinding” (sometimes termed ‘bicarb blinding’) during solution mining. Blinding may occur as the bicarbonate, which has dissolved in the mining solution tends to redeposit out of the solution onto the exposed face of the ore as the carbonate saturation in the solution increases, thus clogging the dissolving face and “blinding” its carbonate values from further dissolution and recovery.

More specifically, the sodium bicarbonate that precipitates out does so upon the surrounding, thus producing a barrier that inhibits the solvent action of the water upon the more water-soluble sodium carbonate trapped and sealed underneath the re-deposited sodium bicarbonate. Blinding can thus slow dissolution and may result in leaving behind significant amounts of reserves in the mine. The net result of this phenomenon is to progressively change the effective composition of the formation upon which the aqueous solvent acts until it appears to be made up of sodium bicarbonate alone. In other words, as more and more of the sodium bicarbonate precipitates out, this deposit seals off the interstices through which the aqueous solvent can gain access to the sodium carbonate in the formation, thereby permitting the aqueous solvent to act upon successively smaller amounts of sodium carbonate until about all the aqueous solvent can reach is the sodium bicarbonate barrier itself.

“Bicarb blinding” is an occurrence which has been recognized as a problem pertaining to solution mining of trona. Methods to address such phenomenon are described, for example, in U.S. Pat. No. 3,184,287 by Gancy. US '287 discloses a method for preventing incongruent dissolution and bicarbonate blinding in the mine by using an aqueous solution of an alkali, such as sodium hydroxide having a pH greater than sodium carbonate, as a solvent for solution mining. In US '287, the aqueous sodium hydroxide solvent used in trona solution mining is regenerated by causticization of aqueous sodium carbonate with lime. U.S. Pat. No. 3,953,073 to Kube and U.S. Pat. No. 4,401,635 to Frint also disclose solution mining methods using a solvent containing sodium hydroxide. US '073 describes the use of aqueous sodium hydroxide for solution mining of trona and nahcolite, and of other NaHCO₃-containing ores, and discloses that the solvent requirements may be met either by causticization of soda ash with hydrated lime or by the electrolytic conversion of sodium chloride to sodium hydroxide. US2013/0171048 by Phillip et al discloses a method comprising an ore dissolution phase in which the incongruent double-salt in trona is dissolved from an ore face in a first solvent, and a cavity cleaning phase in which sodium bicarbonate deposited on the ore face during the dissolution phase is dissolved into a second aqueous solvent having a higher pH, hydroxide content, and/or temperature and is partly or completely converted in situ to sodium carbonate. These patents are hereby incorporated by reference for their teachings concerning solution mining with an aqueous solution of an alkali, such as sodium hydroxide and concerning the making of a sodium hydroxide-containing aqueous solvent via electrodialysis.

Unfortunately, to avoid incongruent dissolution, alkalis such as sodium hydroxide or lime need to be used constantly during solution mining, and because of their high costs, such constant use adversely affects the economics of such solution mining processes.

Therefore it is expected that long term solution mining of a sodium (bi)carbonate-containing mineral may produce brines with lower sodium carbonate values and higher sodium bicarbonate values than those seen initially. This requires that a process be capable of handling the changing brine grade or that incongruent dissolution must be avoided by some means.

In the trona solution mining approach, two or more vertical wells are drilled into the trona bed, and a low pressure connection has been established by directional drilling or hydraulic fracturing.

Directional drilling from the ground surface has been used to connect dual wells for solution mining bedded evaporite deposits and the production of sodium bicarbonate, potash, and salt. Development of nahcolite solution mining cavities by using directionally drilled horizontal holes and vertical wells has been described in U.S. Pat. No. 4,815,790 by Rosar and Day; and the use of directional drilling for trona solution mining has been described in US2003/0029617 by Brown and Nesselrode. However, to improve the lateral expansion of a solution mined cavity in the evaporite deposit, multiple boreholes may be needed, either by a plurality of well pairs for injection and production and/or by a plurality of lateral boreholes in various configurations such as those described in U.S. Pat. No. 8,057,765 by Day et al. The cost of drilling horizontal boreholes and/or of directional drilling can add up. As a result, the benefit in cost savings sought by using solution mining may be negated by the use of expensive drilling operations to improve lateral development of cavity and/or expanding mining area.

In the late 1950's-early 1960's, hydraulic fracturing of trona has been proposed, claimed or discussed in patents as a means to connect two wells positioned in a trona bed by FMC Corporation. See for example U.S. Pat. No. 2,847,202 by Pullen; U.S. Pat. No. 2,952,449 by Bays; U.S. Pat. No. 2,919,909 by Rule; U.S. Pat. No. 3,018,095 by Redlinger et al; and GB897566 by Bays.

In the 1980's, a borehole trona solution mine attempt by FMC Corporation involved connecting multiple conventionally drilled vertical wells along the base of a preferred trona bed by the use of hydraulic fracturing. FMC published a report (Frint, Engineering and Mining Journal, September 1985 “FMC's Newest Goal: Commercial Solution Mining Of Trona” including “Past attempts and failures”) promoting the hydraulic fracture well connection of well pairs as the new development that would commercialize trona solution mining. According to this article though, the application of hydraulic fracturing for trona solution mining was found to be unreliable. Fracture communication attempts failed in some cases and in other cases gained communication between pre-drilled wells but not in the desired manner. The fracture communication project was eventually abandoned in the early 1990's.

The attempts of in situ solution mining of virgin trona in Wyoming were met with less than limited success, and technologies using hydraulic fracturing to connect wells in a trona bed failed to mature commercially.

In the field of oil and gas drilling and operation however, hydraulic fracturing is a mainstay operation, and it is estimated that more than 60% new wells in 2011 used hydraulic fracturing to extract shale gas. Such hydraulic fracturing often employs directional drilling with horizontal section within a shale formation for the purpose of opening up the formation and increasing the flow of gas therefrom to a particular single well using multi-fracking events from one horizontal borehole in the formation.

Through this technique, it has been established that fractures produced in formations should be approximately perpendicular to the axis of the least stress and that in the general state of stress underground, the three principal stresses are unequal (anisotropic conditions). Where the main stress on the formation is the stress of the overburden, these fractures tend to develop in a vertical or inverted conical direction. Horizontal fractures cannot be produced by hydraulic pressures less than the total pressure of the overburden.

The main goal of ‘fracking’ methods in the oil and gas industry is indeed to increase the permeability of shale. Because the depth of the hydraulically-fractured formation is generally greater than 1,000 meters (3,280 ft), the injection pressures in oil and gas exploration are high, even though they are still less than the overburden pressure; this favors the formation of vertical fractures which increases permeability of the exploited shale formation.

In addition, hydraulic fracturing typically uses proppant materials which are capable of enhancing the production of fluids and natural gas from low permeability shale formations. In a typical hydraulic fracturing for oil and gas recovery from shale, a fracturing treatment fluid containing a solid proppant is injected into a wellbore at high pressures. Once natural reservoir pressures are exceeded, the fracturing treatment fluid induces fractures in the shale formation and the proppant is deposited in the fractures, where it remains after the treatment is completed. The proppant serves to hold the fractures open, thereby enhancing the ability of fluids to migrate from the shale formation to the wellbore through the fractures. Because fractured well productivity depends on the ability of a fracture to conduct fluids from a formation to a wellbore, fracture conductivity is an important parameter in determining the degree of success of a hydraulic fracturing treatment in an oil and gas operation. Choosing a proppant is of at most importance to the success of well stimulation.

Unlike the oil and gas exploration from shale formations where it is desirable to produce numerous vertical fractures near the center of the shale formation to increase permeability, for the recovery of trona from underground trona deposits, it is desirable to produce a single fracture substantially at the bottom of a trona bed and along the top of the underlying water-insoluble shale layer from one well and to direct the fracture to the next adjacent well along this trona/shale interface between the bottom of the trona bed to be mined and the top of the shale layer so that the soluble trona can be dissolved from the bottom up.

To allow for the development of a bottom-up solution mining approach of a shallow-depth trona bed having a parting interface with an underlying shale layer, Applicants have developed a lithological displacement technique comprising lifting, and separating, the trona bed from the underlying shale layer by application of a fluid at their interface using a lifting hydraulic pressure. As explained previously, a bed of trona ore typically overlays a floor made of oil shale, which is a water-insoluble incongruent material whereby the interface between these two materials forms a natural plane of weakness. The surface of separation between the trona bed and the underlying shale layer is usually sharply defined and may lie substantially in a horizontal plane especially in the U.S. Green River Basin trona formation. If a sufficient amount of hydraulic pressure is applied at this interface, the two dissimilar substances (trona and shale) should easily separate thereby exposing a large free-surface of trona upon which a suitable solvent can be introduced for in situ solution mining. This free-surface should have a ‘crepe’-like shape of large lateral expansion (more than 100 m) but of very small height (less than 1 cm).

At sufficiently shallow depths which are typically depths of 3,000 ft (914 m) or less, preferably a depth of 2,500 ft (762 m) or less, more preferably a depth of 2,000 ft (610 m) or less, injection pressures equal to or slightly greater than the pressure of the overburden should favor the development of a horizontal fracture, particularly in the case where the desirable target fracture lies along a known plane of weakness between two incongruent materials such as at the interface between trona and oil shale. When the water-soluble trona bed is a nearly horizontal bed underlain by water-insoluble nearly horizontal sedimentary rock, the single main fracture (interface gap) created at their interface is substantially horizontal.

Once a trona free-surface is hydraulically generated by such lifting step, the method may further comprise dissolving trona ore or at least a component of the trona ore from the hydraulically-generated trona free-surface which is in contact with a solvent to form a brine and extracting at least a portion of the brine to the ground surface. Dissolution of trona by the solvent flowing in this interfacial gas will enlarge the gap over time to form a mineral cavity. However, in order to prevent the initially-created interface gap to close on itself, the hydraulic pressure must be maintained or a proppant may be used. Using a proppant may prevent the gap from fully closing upon the release of the hydraulic pressure, forming fluid flow channels through which a production solvent may flow in a subsequent solution mining exploitation phase. But ‘propping’ such trona/shale interface has not been described in the prior art. Although it may be desirable to use proppant in maintaining fluid flow paths in the interface gap, the proppant would be needed only during the interface gap formation and/or during nascent cavity development. Additionally the proppant materials used in the oil and gas industry which are mainly water-insoluble may not be suitable for trona lithological displacement at the trona/shale interface, as they may not be compatible and may hinder brine flow over time.

The present invention thus addresses the development of a lithological displacement method which employs a proppant which is suitable for trona solution mining.

The present invention further provides a remedy to some of the problems associated with ‘bicarb blinding’ during solution mining of trona.

### SUMMARY

According to a first aspect of the present invention, in an underground formation containing an evaporite mineral stratum containing trona, nahcolite, wegscheiderite, and combinations thereof, said evaporite mineral stratum lying immediately above a shale stratum, said formation comprising a defined weak parting interface between the two strata and above which is defined an overburden up to the ground surface, a method for solution mining of said evaporite mineral stratum comprises a lithological displacement of the evaporite mineral stratum, wherein a solid proppant material is placed inside an interface gap which is created by applying at the interface a hydraulic pressure which is greater than the overburden pressure, said interface gap being maintained open by said solid proppant material.

The creation of the interface gap may be carried out simultaneously to the placement of the solid proppant material inside the forming gap.

Alternatively, the creation of the interface gap may be carried out before the placement of the solid proppant material inside the formed gap.

In some embodiments, the method for solution mining of said evaporite mineral stratum comprises:
applying a hydraulic pressure which is greater than the overburden pressure at the interface to lithologically displace the overburden at the interface, thereby forming an interface gap and creating a mineral free-surface, and
injecting a fluid comprising a solid proppant material in said interface gap so as to place said solid proppant material inside said interface gap to keep said interface gap open.

In some embodiments according to the first aspect, the method for solution mining of said evaporite mineral stratum comprises injecting a fluid comprising a solid proppant material at the strata parting interface to lift said evaporite stratum from the underlying shale stratum at a lifting hydraulic pressure greater than the overburden pressure, thereby forming a gap at the interface and creating a mineral free-surface and further placing said solid proppant material inside said interface gap, said interface gap being maintained open by said solid proppant material.

In a variant according to the first aspect where a shale stratum lying immediately below the mineral stratum is softer than the mineral stratum, the method for solution mining of said mineral stratum may comprise:
applying a hydraulic pressure which is greater than the overburden pressure at the interface to lithologically displace the overburden from the trona ore roof, thereby forming an interface gap and creating a trona free-surface and a shale face;
injecting a first fluid comprising a solid sacrificial material in said interface gap so as to place said solid sacrificial material inside said interface gap and permit at least some of said solid sacrificial material to embed into the shale face of the interface gap to create a harder surface on the shale stratum inside the interface gap; and
then, injecting a second fluid comprising a solid proppant material in said interface gap so as to place said solid proppant material inside said interface gap on top of said harder surface.

In some embodiments of such variant, the lithologically displacement step and the first fluid injection step may be done at the same time, in that the first fluid comprising sacrificial particles is injected at the weak parting strata interface to apply such hydraulic pressure which is greater than the overburden pressure to form the interface gap.

In alternate embodiments of such variant, the lithologically displacement step and the first fluid injection step may be done sequentially, in that the first fluid comprising sacrificial particles is injected inside the interface gap after being formed during the lithologically displacement step.

In some embodiments of such variant, the solid sacrificial material may consist of water-insoluble particles.

In some embodiments of such variant, the solid sacrificial material may consist of particles which are harder than the shale stratum but which are as hard or less hard than the evaporite mineral to be mined. This would prevent the solid sacrificial material to embed itself into the mineral free-surface.

In accordance to any or all of the embodiments of the first aspect of the present invention, the lifting hydraulic pressure applied may be characterized by a fracture gradient between 0.9 psi/ft (20.4 kPa/m) and 1.5 psi/ft (34 kPa/m), preferably between 0.95 psi/ft and 1.3 psi/ft, more preferably between 0.95 psi/ft and 1.2 psi/ft, most preferably between 1 psi/ft and 1.1 psi/ft.

In accordance to any or all of the embodiments of the first aspect of the present invention, the lifting hydraulic pressure may be from 0.01% to 50% greater than the overburden pressure at the depth of the interface.

In accordance to any or all of the embodiments of the first aspect of the present invention, the interface between the two strata is preferably at a shallow depth of 3,000 ft (914 m) or less, preferably at a shallow depth of 2,500 ft (762 m) or less.

In accordance to any or all of the embodiments of the first aspect of the present invention, the solid proppant material may comprise water-insoluble tailings, particles comprising an alkali compound, or combinations thereof.

In accordance to any or all of the embodiments of the first aspect of the present invention, the solid proppant material may comprise an alkali compound selected from the group consisting of sodium carbonate, sodium bicarbonate, sodium sesquicarbonate, sodium hydroxide, calcium hydroxide, magnesium hydroxide, ammonium hydroxide, calcium carbonate, and combinations thereof; preferably comprises an alkali compound selected from the group consisting of sodium carbonate, sodium bicarbonate, sodium sesquicarbonate, sodium hydroxide, calcium hydroxide, and combinations thereof; more preferably comprises an alkali compound selected from the group consisting of sodium carbonate, sodium sesquicarbonate, sodium hydroxide, calcium hydroxide, and combinations thereof.

In accordance to any or all of the embodiments of the first aspect of the present invention, the solid proppant material may comprise coated particles, said coated particles including a core comprising a water-soluble compound and a coating comprising a less water-soluble compound. The water-soluble compound in the core preferably comprises or consists of soda ash, trona, or a hydroxide compound. The less water-soluble compound in the coating preferably comprises a water-dissolving polymer compound. In preferred embodiments, the solid proppant material in the injected fluid comprises coated particles, said coated particles including a core of sodium hydroxide, a core of trona, or a core of soda ash.

In accordance to any or all of the embodiments of the first aspect of the present invention, the solid proppant material comprises tailings particles.

The tailings particles used in the solid proppant material may have a particles size of 74 microns or more (200 mesh or less), for example when used ‘as is’ or when used as a particulate core of coated proppant particles.

In accordance to any or all of the embodiments of the first aspect of the present invention, the tailings particles used in the solid proppant material may have a particles size of less than 74 microns (more than 200 mesh), for example when used as a microparticulate reinforcing agent in the coating of coated proppant particles.

In accordance to any or all of the embodiments of the first aspect of the present invention, the injected fluid preferably comprises water or an aqueous solution comprising sodium carbonate, sodium bicarbonate, sodium hydroxide, or combinations thereof.

In accordance to any or all of the embodiments of the first aspect of the present invention, the fluid injection is preferably carried out via a drilled well which comprises an in situ injection zone which is in fluid communication with the parting strata interface, said in situ injection zone comprising a downhole end opening and/or casing perforations.

In accordance to any or all of the embodiments of the first aspect of the present invention, the method further comprises, after placement of such proppant material inside the interface gap, injecting a production solvent into such propped interface gap and dissolving the mineral from the created mineral free-surface to form a brine, thereby enlarging the interface gap to form a mineral cavity.

In accordance to any or all of the embodiments of the first aspect of the present invention, the method further comprises dissolving the proppant with the injected production solvent.

In accordance to alternative or additional embodiments of the first aspect of the present invention, the method comprises reacting at least a portion of the proppant material with at least one component of the injected production solvent.

In accordance to preferred embodiments of the first aspect of the present invention, the mineral stratum comprises trona. Dissolution of trona generates a brine comprising sodium carbonate and also sodium bicarbonate.

According to a second aspect of the present invention, a manufacturing process for making one or more sodium-based products from a stratum comprising trona, comprises:
carrying out the method for solution mining of said evaporite stratum according to any embodiment of the first aspect of the present invention to obtain a brine comprising sodium carbonate and/or sodium bicarbonate by dissolution of the mineral free-surface by a production solvent, and
passing at least a portion of said brine through one or more units selected from the group consisting a crystallizer, a reactor, and an electrodialysis unit, to form at least one sodium-based product.

According to a third aspect of the present invention, a solid proppant material suitable for lithological displacement of a trona stratum from a shale stratum, comprises water-insoluble tailings obtained from a trona refining processing plant, trona particles, soda ash particles, particles of one or more hydroxide compounds, or combinations of two or more thereof.

In accordance to any or all of the embodiments of the third aspect of the present invention, the solid proppant material may comprise coated particles with a water-soluble particulate core and a slow-water dissolving coating, said water-soluble particulate core consisting of trona particles, soda ash particles, or particles of one or more hydroxide compounds, said coating comprising a slow-water dissolving polymeric material.

In accordance to any or all of the embodiments of the third aspect of the present invention, the solid proppant material may comprise or consist of coated particles with a water-soluble particulate core and a slow-water dissolving coating, said water-soluble particulate core comprising an alkali compound, said coating comprising a slow-water dissolving polymeric material in which trona tailings of particle size less than 74 microns are used as microparticulate reinforcing agent.

According to a fourth aspect of the present invention, a fluid comprises the solid proppant material as described herein and further comprises a carrier fluid (preferably a liquid carrier) in which the solid proppant material is suspended.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other methods for carrying out the same purposes of the present invention. It should also be realized by those skilled in the art that such equivalent constructions or methods do not depart from the spirit and scope of the invention as set forth in the appended claims.

### DEFINITIONS AND NOMENCLATURES

For purposes of the present disclosure, certain terms are intended to have the following meanings.

The term ‘evaporite’ is intended to mean a water-soluble sedimentary rock made of, but not limited to, saline minerals such as trona, halite, nahcolite, sylvite, wegscheiderite, that result from precipitation driven by solar evaporation from aqueous brines of marine or lacustrine origin.

The term ‘mined-out’ in front of ‘trona’, ‘evaporite’, ‘ore’, or ‘cavity’ refers to any trona, evaporite, ore, or cavity which has been previously mined.

The term “fracture” when used herein as a verb refers to the propagation of any pre-existing natural fracture(s) and the creation of any new fracture(s; and when used herein as a noun, refers to a fluid flow path in any portion of a formation, stratum or deposit which may be natural or hydraulically generated.

The term ‘lithological displacement’ as used herein to include a hydraulically-generated vertical displacement of an evaporite stratum (lift) at its interface with an (generally underlying) non-evaporite stratum. A “lithological displacement” may also include a lateral (horizontal) displacement of the evaporite stratum (slip), but slip is preferably avoided.

The term ‘overburden’ is defined as the column of material located above the target interface up to the ground surface. This overburden applies a pressure onto the interface which is identified by an overburden gradient (also called ‘overburden stress’, ‘gravitational stress’, ‘lithostatic stress’) in a vertical axis.

The term ‘TA’ or ‘Total Alkali’ as used herein refers to the weight percent in solution of sodium carbonate and/or sodium bicarbonate (which latter is conventionally expressed in terms of its equivalent sodium carbonate content) and is calculated as follows: TA wt %=(wt % Na₂CO₃)+0.631 (wt % NaHCO₃). For example, a solution containing 17 weight percent Na₂CO₃ and 4 weight percent NaHCO₃ would have a TA of 19.5 weight percent.

The term “(bi)carbonate” refers to the presence of both sodium bicarbonate and sodium carbonate in a composition, whether being in solid form (such as trona) or being in liquid form (such as a liquor). For example, a (bi)carbonate-containing stream describes a stream which contains both sodium bicarbonate and sodium carbonate.

The term ‘brine’ represents a solution containing a solvent and a solute such as dissolved mineral (e.g., trona) or at least one dissolved component of such mineral. A brine may be unsaturated or saturated in the at least one dissolved component of such mineral.

The term ‘solvent-contacted’ in front of ‘trona’, ‘mineral’, “surface’, ‘face’ refers to any trona, mineral, surface, face which is in contact with a solvent or fluid.

As used herein, the term “solute” refers to a compound (e.g., mineral) which is soluble in water or an aqueous solution, unless otherwise stated in the disclosure.

As used herein, the terms “solubility”, “soluble”, “insoluble” as used herein generally refer to solubility/insolubility of a compound or solute in water or in an aqueous solution, unless otherwise stated in the disclosure.

In the context of proppant composition, the term “slow-water soluble” as used herein refers to component(s) of the proppant, of the particulate core, or of the coating (e.g., resins, polymers) in coated particles which may be stable (i.e., may not dissolve) under ambient, surface conditions, but which become soluble in the solvent after a given time (usually over several hours or several days) when placed in the subterranean environment. A “slow-water soluble” component in the proppant material starts dissolving at least 0.5 hour, preferably at least 1 hour, more preferably at least 2 hours, yet more preferably at least 3 hours, or even at least 6 hours, after contact with the solvent, especially the production solvent. A “slow-water soluble” component in the proppant may be completely dissolved after a period of contact time with the solvent of at most 1 month, or at most 15 days, or at most 7 days, or even at most 3 days. In relative terms, the dissolution rate of a “slow-water soluble” component in a coating of the proppant material should be less than water-soluble component(s) in the core of the proppant material.

In the context of proppant composition, the term “reactive” as used herein refers to component(s) of the proppant, particulate core or coating in coated proppant particles which may be stable (i.e., may not react) under ambient, surface conditions, but which react with at least one component of the production solvent after a given time (usually over several hours or several days) when placed in contact with the production solvent in the subterranean environment. A “reactive” component in the proppant should start reacting with at least one component of the production solvent preferably at least 10 minutes, more preferably at least 30 minutes, yet more preferably at least 1 hour, or even at least 2 hours, after contact with the production solvent. A “reactive” component in the proppant may be completely reacted after a period of contact time with the production solvent of at most 1 month, or at most 15 days, or at most 7 days, or even at most 3 days.

The term “solution” as used herein refers to a composition which contains at least one solute in a solvent.

The term “suspension” refers to a composition which contains solid particles suspended in a liquid phase.

As used herein, the term “propping” refers to the technique of placing a solid proppant material at the evaporite/non-evaporite strata interface to maintain the interface gap open.

As used herein for a fluid comprising solid particles in a liquid carrier, the term “substantially-neutrally buoyant” refers to particles that have an apparent specific gravity (ASG) sufficiently close to the apparent specific gravity of the selected carrier fluid which allows pumping and satisfactory placement of the particles using the selected carrier fluid inside the interface gap during lithological displacement.

In the present application, where an element or component is said to be included in and/or selected from a list of recited elements or components, it should be understood that in related embodiments explicitly contemplated herein, the element or component can also be any one of the individual recited elements or components, or can also be selected from a group consisting of any two or more of the explicitly listed elements or components, or any element or component recited in a list of recited elements or components may be omitted from this list. Further, it should be understood that elements and/or features of a composition, an apparatus, or a method described herein can be combined in a variety of ways without departing from the scope and disclosures of the present teachings, whether explicit or implicit herein.

The use of the singular herein includes the plural (and vice versa) unless specifically stated otherwise.

In addition, if the term “about” or “ca.” is used before a quantitative value, the present teachings also include the specific quantitative value itself, unless specifically stated otherwise. As used herein, the term “about” or “ca.” refers to a +−10% variation from the nominal value unless specifically stated otherwise.

The phrase ‘A and/or B’ refers to the following choices: element A; or element B; or combination of A and B (A+B).

The phrase ‘A1, A2, . . . and/or An’ with n≧3 refers to the following choices: any single element Ai (i=1, 2, . . . n); or any sub-combinations of less than n elements Ai; or combination of all elements Ai.

It should be understood that throughout this specification, when a range is described as being useful, or suitable, or the like, it is intended that any and every amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 1.5” is to be read as indicating each and every possible number along the continuum between about 1 and about 1.5. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

The term ‘comprising’ includes “consisting essentially of” and also “consisting of”. Unless otherwise noted, the terms “a” or “an” are to be construed as meaning “at least one of” or ‘one or more’ and include the plural.

### DETAILED DESCRIPTION OF THE PREFERRED EMBODIMENTS

The following detailed description illustrates embodiments of the present invention by way of example and not necessarily by way of limitation.

It should be noted that any feature described with respect to one aspect or one embodiment is interchangeable with another aspect or embodiment unless otherwise stated.

The present invention relates to in situ solution mining of an evaporite mineral in an underground formation comprising an evaporite mineral stratum in which the mineral is soluble in a removal (liquid) solvent, such evaporite stratum lying immediately above a non-evaporite stratum of a different composition which is insoluble in such removal solvent, wherein the underground formation has a defined weak parting interface between the two strata, in which an interface gap is initially created by lithologically displacement (lift) of the evaporite stratum and the overburden at the interface by application of a lifting hydraulic pressure greater than the overburden pressure, thereby forming a gap (main fracture) between the strata and creating a mineral free-surface.

The lifting hydraulic pressure is applied by injecting a fluid at a strata interface (preferably injected at a specific steady volumetric flow rate) until the desired lifting hydraulic pressure is reached. The fluid used during the lifting step may be termed ‘lifting fluid’ or ‘lithological displacement fluid’. Such fluid preferably comprises solid particles suspended in a carrier fluid.

The injected fluid may comprise a solvent suitable for dissolving the mineral (such as trona), but not necessarily. Preferably, the injected fluid is preferably in liquid form and comprises solid particles. The solid material may serve as proppant and helps maintaining the interface gap open when the hydraulic pressure at the interface is reduced to a value lower than what would be necessary to lift the overburden.

In preferred embodiments, the method further comprises solution mining of the evaporite mineral in which a production solvent is injected into the strata interface gap (main fracture) to come in contact with the mineral free-surface. The gap is enlarged by dissolution of mineral from the solvent-contacted mineral free-surface, thereby creating a mineral cavity and generating a brine containing dissolved mineral (or a dissolved component from the mineral). At least a portion of the brine is extracted from the interface gap to the ground surface. In the case of trona, since trona contains mainly sodium sesquicarbonate (a double-salt of sodium carbonate and sodium bicarbonate), the solutes from trona in the brine are generally sodium carbonate and sodium bicarbonate.

In preferred embodiments, the method further comprises dissolving the proppant, or at least a part thereof, when the proppant is in contact with the production solvent.

In alternate or additional embodiments, the method further comprises degrading the proppant by reaction of at least a component thereof when the proppant is in contact with the production solvent. Such reaction may be hydrolysis. The sub-particles of proppant which may be generated by such degradation preferably are also soluble in the production solvent.

The various embodiments of the method according to the present invention will now be described in relation to trona, but it should be understood that such method is equally applicable to other soluble evaporite mineral which has a defined weak parting interface with a non-evaporite insoluble stratum.

In general terms, the present application relates to a solid proppant material, a fluid comprising such proppant, and its use in lithological displacement of a trona stratum at its interface with a shale layer.

The preferred solid proppant material may be selected from the group consisting of:

A/ a proppant material comprising trona tailings (preferably with a particle size of 74 microns or more);

B/ a proppant material comprising an alkali compound (preferably trona, soda ash, or a hydroxide compound); and

C/ combinations thereof.

The solid proppant material may be coated proppant particles which comprise a water-soluble core and a less-soluble coating, in which the core may comprise or consist of trona, soda ash, or a hydroxide compound (preferably NaOH or Ca(OH)2) and/or in which the coating may comprise trona tailings (preferably with a particle size of less than 74 microns) used as reinforcing agent.

The solid proppant material may be coated proppant particles which comprise a water-soluble core and a water-reactive coating, in which the core may comprise or consist of trona, soda ash, or a hydroxide compound (preferably NaOH or Ca(OH)2) and/or in which the coating may comprise a material which reacts with water, such as gets hydrolyzed.

Trona Stratum and its Interface with Shale Stratum

A trona stratum may contain up to 99 wt % sodium sesquicarbonate, preferably from 25 to 98 wt % sodium sesquicarbonate, more preferably from 50 to 97 wt % sodium sesquicarbonate.

The trona stratum may contain up to 1 wt % sodium chloride, preferably up to 0.8 wt % NaCl, yet more preferably up to 0.2 wt % NaCl.

The defined parting interface between the trona stratum and the shale stratum is preferably horizontal or near-horizontal, but not necessarily. The interface may be characterized by a dip of 5 degrees or less; preferably with a dip of 3 degrees or less; more preferably with a dip of 1 degrees or less. The defined parting interface may have a dip greater than 5 degrees up to 45 degrees or more.

The trona/shale interface may be at a shallow depth of less than 3,280 ft (1,000 m) or at a depth of 3,000 ft (914 m) or less, preferably at a depth of 2,500 ft (762 m) or less, more preferably at a depth of 2,000 ft (610 m) or less. The trona/shale interface may at a depth of more than 800 ft (244 m).

In the Green River Basin, the trona/oil shale parting interface may be at a shallow depth of from 800 to 2,500 feet (244-762 m). The trona stratum may have a thickness of from 5 feet to 30 feet (1.5-9.1 m), or may be thinner with a thickness from 5 to 15 feet (1.5-4.6 m).

### Lifting Fluid Injection Via a Well

Lifting fluid injection may be carried out via a vertical well or a directionally drilled well. The injection may be carried out by pumping the fluid downhole, for example in tubing string placed inside such injection well.

The method according to the present invention may further comprise forming at least one fully cased and cemented well which intersects the trona/shale strata interface. This well will serve as an injection well and/or may serve as a production well.

Forming the well may include drilling a well from the surface to at least the depth of a target injection zone which is located neat or at the interface between the target bed of trona and the shale stratum, followed by casing and cementing the well.

The well is preferably fully cemented and cased but with a downhole section which provides at least one in situ injection zone which is in fluid communication with the strata interface.

The downhole well section may be a portion of the fully cemented and cased well which comprises at least one casing opening (which provides at least one in situ injection zone) which is in fluid communication with the strata interface. The lifting fluid (e.g., solvent) can flow through the opening(s) between the inside of the well and the strata interface.

The in situ injection zone should allow for the fluid to be injected into the well and to be directed at the interface. The in situ injection zone is preferably, albeit not necessarily, designed to laterally inject the fluid in order to avoid injection of fluid in a vertical direction. The in situ injection zone allows the fluid to force a path at the trona/shale interface by vertically displacing the trona stratum to create the gap.

The in situ injection zone may comprise one or more downhole casing openings. The casing of a well downhole section may be perforated and/or the well may be otherwise left open at the interface to expose the target in situ injection zone.

A downhole vertical section of the vertical well may have a downhole end opening which is located at or near the parting interface. The vertical borehole section may have, alternatively or additionally, perforations which are aligned with the interface. Using a downhole perforating tool, these perforations may be cut through the casing and cement at a well circumference aligned with the interface to form the in situ injection zone.

When the well is vertical, the in situ injection zone may comprise or consist of perforations (casing openings) in the downhole section of the well casing, preferably aligned alongside the strata interface. When the vertical well goes through the interface which is horizontal or near horizontal, perforations (casing openings) are preferably positioned on at least one casing circumference of this downhole section, such casing circumference being aligned alongside the strata interface.

When the well is directionally drilled, the directionally drilled well comprises an in situ injection zone which is located at or near the parting interface, wherein the injection zone may comprise or consist of an end opening of a horizontal downhole section of the well and/or specific casing perforations in the horizontal downhole section of the well casing, for example perforations on one sidewall or on opposite sidewalls of the well horizontal section which are aligned alongside the strata interface (such as a row of perforations on either sidewall or both sidewalls of the horizontal downhole section). In this instance, when the lifting fluid exits the in situ injection zone (well end opening and/or casing perforations) thereby lifting the overlying trona stratum at the interface, the gap created at the interface is an extension of such horizontal borehole section.

The method may further comprise perforating the casing on one lateral side or opposite lateral sides of a horizontal well section or on at least one circumference on a vertical well section, so as to create casing perforations aligned alongside the interface. When the interface is horizontal or near-horizontal, this perforating step may be carried out to allow passage of the injected fluid in a preferential lateral way through the formed perforations towards the horizontal or near-horizontal interface.

The opening(s) on the casing may be in fluid communication with a conduit inserted into the well to facilitate fluid flow from the ground surface to this well in situ injection zone.

The lifting fluid can flow inside the casing of well or may be injected via a conduit all the way to the in situ injection zone. Such conduit may be inserted inside the injection well to facilitate injection of fluid. The conduit may be inserted while the injection well is drilled, or may be inserted after drilling is complete. The injection conduit may comprise a tubing string, where tubes are connected end-to-end to each other in a series in a somewhat seamless fashion. The injection conduit may comprise or consist of a coiled tubing, where the conduit is a seamless flexible single tubular unit. The injection conduit may be made of any suitable material, such as for example steel or any suitable polymeric material (e.g., high-density polyethylene). The injection conduit inside the well should be in fluid communication with the in situ injection zone.

The well when vertical is preferably drilled from the ground surface past the depth of the interface. The section of the well which is underneath the interface may be plugged from the bottom of the well up to the interface for the lifting step. The depth at which the bottom of the well section which is underneath the interface lies (where the drilling of well stops) may be at least 5 feet below the depth of interface, preferably between 10 feet and 100 feet below the depth of interface, more preferably between 30 feet and 80 feet below the depth of interface.

Alternatively, the section of the well which is underneath the interface may comprise a collection zone (also termed a sump) and is preferably cased and cemented to collect the brine and/or insolubles. The section of the well which is underneath the interface may be initially plugged from the bottom of the well up to the interface for the lifting step and then drilled to form the sump to collect brine and possibly insolubles (e.g., remaining after trona dissolution and/or intentionally added by mine operator).

In at least one embodiment, the in situ injection zone may be intentionally widened to form a ‘pre-lift’ slot between the overlying trona stratum and the underlying insoluble shale stratum, this ‘pre-lift’ slot providing a pre-existing “initial lifting surface” which would allow the hydraulic pressure exerted by the injected fluid to act upon this initial lifting surface preferentially in order to begin the initial separation of the two strata. The pre-lift slot may be created by directionally injecting a fluid (preferably comprising a solvent suitable to dissolve the trona) under pressure via a rotating jet gun.

The surface temperature of the injected lifting fluid can vary from 32° F. (0° C.) to 250° F. (121° C.), preferably up to 220° F. (104° C.).

When the lifting fluid comprises a solvent suitable for dissolving the mineral, the higher the temperature of the injected fluid, the higher the rate of dissolution of mineral at and near the point of injection.

Before injection, the lifting fluid may be preheated to a predetermined temperature which is higher than the in situ temperature of the trona stratum. When the injected fluid comprises a solvent for dissolving trona, the fluid may be preheated to increase the solubility of one or more desired solutes present in the tronal ore.

The lifting fluid may be injected from the ground surface to the interface at a surface temperature at least 20° C. higher than the in situ temperature of the trona stratum.

The lifting fluid may be injected from the ground surface to the interface at a surface temperature which is near the ambient rock temperature (the in situ temperature) at the injection depth. The surface temperature of the fluid may be within +/−5° C. or within +/−3° C. of the in situ temperature of the evaporite stratum. Since the in situ temperature of trona stratum 5 is estimated to be about 30-36° C. (86-96.8° F.), preferably 31-35° C. (87.8-95° F.), the surface temperature of the fluid may be between about 25 and about 41° C. (about 77-106° F.).

For trona solution mining, the surface temperature of the fluid injected for the lifting step, and/or of the fluid injected for propping step (if different than lifting fluid) and/or of the fluid injected for dissolution step may be between 59° F. and 194° F. (15-90° C.) or between 100° F. and 150° F. (37.8-65.6° C.), or between 122° F. and 176° F. (50-80° C.), or between 140° F. and 176° F. (60-80° C.), more preferably between 140° F. (60° C.) and 158° F. (70° C.), most preferably about 149° F. (65° C.).

Any of these fluid may be injected at a volumetric flow rate from 9 to 477 cubic meters per hour (m³/hr) [42-2100 gallons per minute or 1-50 barrels per minute]; from 11 to 228 m³/hr [50-1000 GPM or 1.2-23.8 BBL/min]; or from 13 to 114 m³/hr (60-500 GPM or 1.4-11.9 BBL/min); or from 16 to 45 m³/hr (70-200 GPM or 1.7-4.8 BBL/min); or from 20 to 25 m³/hr (88-110 GPM or 2.1-2.6 BBL/min).

### Injected Fluid Comprising Particles

During or after the lithological displacement step in which the trona stratum is lifting from the underlying shale stratum at their interface (also termed the ‘lifting step’), the method may include injecting a fluid which comprises particles suspended in a carrier fluid.

Any carrier fluid suitable for transporting the particles into the interface may be employed including, but not limited to, carrier fluids including unviscosified water, fresh water, an aqueous solution containing sodium (bi)carbonate, and/or a gas such as nitrogen or carbon dioxide. In a preferred embodiment, the carrier fluid is unviscosified water or an aqueous solution comprising sodium carbonate, preferably unsaturated in sodium carbonate.

The carrier fluid may be gelled, non-gelled or have a reduced or lighter gelling requirement. The latter may be referred to as “weakly gelled”, i.e., having minimum sufficient polymer, thickening agent, such as a viscosifier, or friction reducer to achieve friction reduction when pumped downhole (e.g., in tubing string), and/or may be characterized as having a polymer or viscosifier concentration of from greater than 0 pounds of polymer per thousand gallons of fluid to about 10 pounds of polymer per thousand gallons of fluid, and/or as having a viscosity of from about 1 to about 10 centipoises. The non-gelled carrier fluid typically contains no polymer or viscosifer.

The use of a non-gelled carrier fluid eliminates a source of underground formation damage and enhancement in the productivity of the interface gap into which the fluid is injected. Elimination of the need to formulate a complex suspension especially in gel form may further mean a reduction in tubing friction pressures and in the amount of on-location mixing equipment and/or mixing time requirements, as well as reduced raw material costs.

In embodiments employing substantially-neutrally buoyant particles and a selected carrier fluid, mixing equipment need only include such equipment that is capable of homogeneously dispersing the substantially-neutrally buoyant particles in the selected carrier fluid (e.g., ungelled or weakly gelled aqueous solution or water). The “substantially-neutrally buoyant” particles have an apparent specific gravity (ASG) sufficiently close to the apparent specific gravity of the selected carrier fluid which allows pumping and satisfactory placement of the particles using the selected carrier fluid inside the interface gap during lithological displacement.

The proppant particles may be advantageously pre-suspended as a substantially-neutrally buoyant particles and stored in the carrier fluid (e.g., water or aqueous solution of near or substantially equal density), and then injected (e.g., pumped) downhole at the strata interface ‘as is’, or diluted as needed.

In preferred embodiments, the injected fluid may comprise, or consist of, a suspension comprising particles suspended in a carrier liquid, wherein such carrier liquid comprises water or an aqueous sodium (bi)carbonate-containing solution.

The carrier liquid in the injected fluid may comprise water. The water in the carrier liquid may originate from natural sources of fresh water, such as from rivers or lakes, or may be a treated water, such as a water stream exiting a wastewater treatment facility.

The carrier liquid in the injected fluid may comprise an aqueous solution comprising at least one solute of trona (sodium carbonate and/or sodium bicarbonate).

The carrier liquid in the injected fluid may be caustic or acidic or neutral, preferably caustic or neutral. In preferred embodiments, the carrier liquid is caustic, that is to say, have a pH greater than 7, preferably greater than 8.

The carrier liquid may contain ammonium hydroxide or at least one alkali metal or alkaline earth metal hydroxide compound, such as sodium hydroxide, calcium hydroxide, magnesium hydroxide, or combinations thereof, or any other bases.

When the evaporite stratum comprises trona, the carrier liquid in the injected fluid preferably comprises water or an unsaturated aqueous solution comprising sodium carbonate, sodium bicarbonate, sodium hydroxide, calcium hydroxide, or combinations thereof.

Water or an unsaturated sodium (bi)carbonate solution is preferably used in the carrier liquid of the injected fluid to dissolve trona from the free-surfaces in the trona/shale interface gap and to enlarge this interface gap quickly by trona dissolution to form the cavity.

In alternate albeit less preferred embodiments, the carrier fluid is non-aqueous, such as is an organic fluid or is CO2.

In some embodiments when there is a risk of proppant embedment into the underlying shale stratum (softer stratum), there may be at least two injected fluids used in the method according to the present invention.

A first injected fluid which comprises ‘sacrificial’ particles (preferably which are harder than the material in the underlying shale layer) may be injected at the weak parting strata interface (either during hydraulic lifting or thereafter), so that these ‘sacrificial’ particles are permitted to embed into the softer shale stratum. This will allow the formation of a hard layer on the shale free face created when the interface gap is formed. This hard underlying layer thus may serve as a foundation onto which proppant particles injected via a second fluid may lay. In this manner, the second fluid comprises such proppant particles may be injected to keep the interface gap open. The ‘sacrificial’ particles in the first injected fluid are preferably water-insoluble. Since it is intended for the ‘sacrificial’ particles in the first injected fluid to be embedded into the shale free face, there is no need to use a tight sieve distribution of ‘sacrificial’ particles in the first fluid. Since there should be no dissolution from the underlying shale stratum, the embedment of insoluble sacrificial particles into the underlying shale stratum will not negatively impact the productivity of the mineral cavity formed from the interface gap. The second injected fluid preferably comprises slow-dissolving and/or slow-degrading particles which serve initially as proppant to allow sufficient fluid flow in the interface gap for the production solvent to dissolve trona from the trona free-surface of the interface gap and as slow-dissolving and/or slow-degrading particles dissolve or degrade, the particles preferably release compounds that do not negatively impact the quality of the brine and/or may even be beneficial to trona dissolution (such as releasing a hydroxide compound to convert, inside the gap, sodium bicarbonate dissolved from trona to sodium carbonate which has a better water solubility).

### Solid Proppant Material

The solid particles in the injected fluid preferably comprise, or more preferably consist essentially of, solid proppant particles.

In order to maintain and/or enhance the flowability of the hydraulically-created gap at the trona/shale strata interface, proppant particles with high compressive strength (often simply referred to as “proppant”) may be deposited inside the interface gap, for example, by injecting the fluid carrying the proppant. The proppant particles may prevent the gap from fully closing upon the release of the hydraulic pressure, forming fluid flow channels through which a production solvent may flow in a subsequent solution mining exploitation phase. The technique of placing proppant in the interface gap may be referred to herein as “propping” the strata interface.

The proppant particles may have a compressive strength of at least 2300 psi or at least 2500 psi, preferably of at least 3000 psi, more preferably of at least 3500 psi.

When the solid proppant particles are employed in a formation having high closure stresses, the apparent specific gravity (ASG) of the proppant particles is preferably between from about 1.0 to about 4.0. The apparent specific gravity (ASG) represents how dense each particle is. In such applications, lithological displacement may be conducted at closure stresses greater than about 1500 psi and at temperatures ranges between ambient and 100° C. For use in lower closure stresses, the ASG of the solid proppant particles may be less than or equal to 2.6, generally between from about 1.05 to about 2.55. Increasing the apparent specific gravity of the solid proppant particles leads directly to increasing degree of difficulty with proppant transport to carry it at the strata interface, and as a result reduces the amount of proppant which can be used in the interface gap, thereby reducing the effectiveness of the proppant to keep the interface gap open. It is to be noted that the specific gravity for trona is about from 2.11 to 2.17, trona bulk density being about from 1.089 to 1.315 g/cm³; the specific gravity for soda ash is about 2.53, the bulk density of dense soda ash being about from 0.86 to 1.09 g/cm³ and the bulk density of light soda ash being about from 0.48 to 0.67 g/cm³; and the specific gravity for sodium hydroxide is about 2.13, and its bulk density being about 0.96 g/cm³.

The solid proppant material may be present in the carrier liquid in an amount from about 0.001 pounds per gallon to about 16 pounds per gallon of the carrier liquid, preferably from about 0.1 pounds per gallon to about 12 pounds per gallon of the carrier liquid.

The loading of the solid proppant material may increase during the propping step. For example, the content of solid proppant material in the fluid may start from 0.5 to 2 pounds per gallon (lb/gal) and may increase up to 12 lb/gal or more during the propping step. Final proppant loading near the in situ injection point of the well may be as high as 12 lb/gal or even more.

The solid proppant material loading inside the interface gap may be greater than about 0.2 pounds per square foot (lb/ft²) and/or up to about 4 lb/ft². Preferred solid proppant material loading in the interface gap may be at least about 0.5 lb/ft² and/or up to about 2 lb/ft².

The loading of the solid proppant material is preferably high enough to allow a proppant density greater than what is need to achieve a monolayer of proppant per square foot of surface are in the interface gap. The loading of the solid proppant material is preferably high enough to a plurality of proppant layers, thereby creating a proppant loose pack. The proppant pack may correspond from 3 layers up to 7 layers of proppant inside the interface gap. The greater the number of proppant layers, the higher the width of the interface gap. The width is the distance between the two faces (mineral face and shale face) created in the interface gap. The density of the loose pack generally relates to the bulk density of the proppant.

In preferred embodiments, the solid proppant material or at least a portion thereof preferably dissolves or degrades in the later-injected production solvent during trona exploitation.

Although it may be desirable to use a proppant in maintaining fluid flow paths in the interface gap, ‘propping’ the interface gap becomes unnecessary when the interface gap is sufficiently enlarged by dissolution of trona by the carrier liquid if it contains water and is unsaturated in sodium carbonate and/or by the aqueous production solvent to form a mineral cavity.

As such, the proppant used during the lifting step is generally needed only during the interface gap formation and/or during nascent cavity development. For that reason, in preferred embodiments, at least one component of the solid proppant material according to the present invention preferably dissolves in an injected production solvent and/or reacts with at least one component of the production solvent. Such dissolution or reaction in the proppant results in degrading the proppant solid structure, thus ultimately disintegrating the proppant during the subsequent trona dissolution step.

The solid proppant material may also dissolve and/or react in the carrier liquid of the injected fluid; however in such instance, the dissolution and/or reaction of the solid proppant material during lithological displacement should be slow so as to preserve the effectiveness of the solid proppant material to maintain the interface gap open after the lifting step is completed. For that reason, it may be preferred to use coated proppant particles which comprises a slow-water dissolving coating which slowly dissolves in the production solvent and/or a reactive coating which degrades when in contact with the production solvent.

In the present invention, the proppant injected into the interface gap is preferably a temporary proppant. Because the region (gap) into which it is injected contains a water-soluble free-surface which will dissolve mineral in a subsequently used production solvent, the width of the interface gap will be enlarged and as such the gap will not longer need to be ‘propped’. The solid proppant material described herein thus only need to function as ‘proppant’ at the beginning of the solution mining process where the trona cavity is being formed by enlargement of the interface gap.

For that reason, it is desirable that the present solid proppant material dissolves or disintegrates over time. The present solid proppant material may shrink in its size or may even break as the proppant structure gets weakened by dissolution and/or reaction. These smaller particles or subparticles would dissolve even faster.

This is contrary to what is expected from a proppant used in oil and gas hydrofracturing technique. Proppant fines formation and the resulting migration in the fractures are considered to be one of the major contributors to poor well performance. It has been estimated that just 5% fines can decrease fracture flow capacity by as much as 60%. Use of resin coated proppants or even those using grain-to-grain bonding technology reduces fines generation and migration through proppant pack inside the fractures. This resin coating can also encapsulate any loose fines that may occur. As such oil and gas hydrofracturing operators go to great length to avoid disintegration of proppant particles.

This is not the case in preferred embodiments of the present invention. It is intended for at least a portion of the solid proppant material to only serve as proppant momentarily and for this proppant material to dissolve away. As such it is preferred that the compositions of such solid proppant material to comprise a majority of components which are compatible with the trona formation and which will not have a negative impact when dissolved in the carrier liquid of the injected fluid and more importantly in the production solvent used in the subsequent solution mining. In various aspects of the present invention, the solid proppant may comprise particles containing at least one alkali compound, water-insoluble trona tailings, or combinations thereof.

In a first embodiment, the solid proppant used in the present lithological displacement step comprises particles containing at least one alkali compound, preferably particles containing trona, soda ash, or an alkali metal or alkaline earth metal inorganic compound.

The particles containing at least one alkali compound may slowly dissolve as in a time-release mechanism. Gradual dissolution of the alkali may insure that the alkali is available in situ for extended periods of time.

In the case of hydroxide compound particles, the hydroxide is available for chemical modification of the deposited sodium bicarbonate to carbonate within the trona cavity which would minimize bicarbonate blinding during trona dissolution.

The alkali compound in the solid proppant material may be selected from the group consisting of sodium carbonate (also known as soda ash), sodium bicarbonate, sodium sesquicarbonate (main component of trona), sodium hydroxide, calcium hydroxide, calcium carbonate, calcium carbonate, magnesium hydroxide, ammonium hydroxide, and combinations thereof.

In some embodiments of the first embodiment, the solid proppant material may comprise a hydroxide compound selected from the group consisting of sodium hydroxide, calcium hydroxide, magnesium hydroxide, and combinations thereof; preferably selected from the group consisting of sodium hydroxide, calcium hydroxide, and combinations thereof. More preferably the solid proppant material may comprise particles consisting essentially of sodium hydroxide.

One of the advantages of the use of a hydroxide compound (in particular NaOH or Ca(OH)2) in the proppant particle is to the release of the hydroxide compound during the trona dissolution step. As explained previously, the incongruent solubilities of sodium carbonate and sodium bicarbonate present as a double-salt in trona can cause sodium bicarbonate “blinding” during solution mining. Applicants thus provide a remedy to this issue, by using the in situ release of a hydroxide compound (e.g., NaOH or Ca(OH)2) from the proppant inside the interface gap and later inside the formed cavity during the trona dissolution step. The release (by dissolution) of NaOH or Ca(OH)2 from the proppant—which is lodged inside the interface gap and likely also deposited at the bottom of the formed cavity into the brine will permit the conversion of sodium bicarbonate with hydroxide to form the more-soluble sodium carbonate, thereby preventing incongruent dissolution and bicarbonate blinding in the mine.

In some embodiments of the first aspect, the solid proppant material may comprise, or consist of, soda ash particles.

In additional or alternate embodiments of the first aspect, the solid proppant material may comprise, or consist of, trona particles.

One of the advantages of the use of soda ash or trona in the proppant particles is to the release of the same sodium (bi)carbonate species from the proppant in the production solvent, which would enrich the brine in desired solutes and not cause any incompatibility issue.

In a second embodiment, the solid proppant comprises trona tailings. Trona tailings are particles obtained in a surface refinery processing mechanically-mined trona. The tailings particles used in the solid proppant preferably have a particles size of 74 microns or more (200 mesh or less) when used ‘as is’ as proppant particles or when used as a particulate core of coated proppant particles. The tailings particles used in the solid proppant may have a lower average particle size of 37 microns or less (400 mesh or more) when used as sub-particles in compounded proppant particles or as a microparticulate reinforcing agent embedded in the coating of coated proppant particles.

Tailings in trona processing represent a water-insoluble matter recovered after a mechanically-mined trona is dissolved (generally after being calcined) in the surface refinery. During the mechanical mining of a trona stratum, some portions of the underlying floor and overlying roof rock which contain oil shale, mudstone, and claystone, as well as interbebded material, get extracted concurrently with the trona. The resulting mechanically-mined trona feedstock which is sent to the surface refinery may range in purity from a low of 75 percent to a high of nearly 95 percent trona. The surface refinery dissolves this feedstock (generally after a calcination step) in water or an aqueous medium to recover alkali values, and the portion which is non-soluble, e.g., the oil shale, mudstone, claystone, and interbedded material, is referred to as ‘insols’ or ‘tailings’. After trona dissolution, the tailings are separated from the sodium carbonate-containing liquor by a solid/liquid separation system.

The particles size of trona tailings may vary depending on the surface refinery operations. Typical trona tailings may have particle sizes ranging between 1 micron and 250 microns, although bigger and smaller sizes may be obtained. More than 50% of the particles in tailings generally have a particle size between 5 and 100 microns.

The full range of the trona tailings may be used as water-insoluble proppant particles in the injected fluid. Alternatively, a fraction of the full range of tailings may be used as water-insoluble particles in the injected fluid. For example, a size-separation apparatus (e.g., wet sieve apparatus) may be used to isolate a specific particles fraction, such as isolating particles passing through a sieve with a specific size cut-off (such as 74 μm=200 mesh) and isolating particles retained by the sieve. The finer particles of tailings (retained by the sieve) may be used as a water-insoluble proppant or as core of a coated proppant in the injected fluid. Alternatively although less preferred, the finer particles of tailings (passing through the sieve) may be used as water-insoluble sub-particles in the proppant of the injected fluid. The specific size cut-off for the sieve may be preferably 74 microns (200 mesh), or alternatively 44 microns (325 mesh); or even 37 microns (400 mesh). The fraction of water-insoluble tailings used in proppant particles in the injected fluid may be isolated using two sieves with two size cutoffs.

In a third embodiment, the solid proppant comprises trona tailings and particles containing an alkali compound, both types of particles being in suspension in the carrier fluid. For example, the solid proppant may comprise trona tailing particles and particles of a hydroxide compound, both types of particles being in suspension in water or an aqueous solution comprising sodium carbonate, sodium bicarbonate, sodium hydroxide, calcium hydroxide, or combinations thereof. In another example, the solid proppant may comprise tailing particles and particles selected from the group consisting of trona particles, soda ash particles, and mixtures thereof, wherein both types of particles are in suspension in water or an aqueous solution comprising sodium carbonate, sodium bicarbonate, sodium hydroxide, or combinations thereof.

In additional embodiments, the solid proppant may further comprise any particulate material which is known to function as a proppant in oil and gas hydraulic fracturing applications. Such materials are well known and described in numerous prior patents and publications, examples of which include U.S. Pat. No. 5,422,183; EP0562879; U.S. Pat. No. 6,114,410; U.S. Pat. No. 6,528,157; WO2005/003514; US2005/0194141; and US2006/0175059, each being incorporated herein by reference. Of particular interest, the optional proppant may be a material selected from the group consisting of conventional ‘frac’ sand (silica); man-made ceramics such as sintered bauxite, aluminum oxide and zirconium oxide; synthetic proppants (e.g., proppants made from synthetic resins); metallic proppants; naturally-occurring proppants (e.g., made from nut shells and fruit pits); any resin impregnated or resin coated version of these; and mixtures thereof. Specific examples for this optional proppant for silica proppants; ceramic proppants; synthetic proppants; metallic proppants; and naturally-occurring proppants can be found in US2006/0175059.

The proppant particles in the injected fluid preferably have a tight sieve distribution and have a high strength (low crush).

The particle size of the proppant particles in the injected fluid may be from 74 microns to 4 mm, particularly from 74 microns to 3.25 mm (200 to 6 mesh). Preferably, the particle size of the proppant particles may be from 152 microns to 1.68 microns (100 mesh to 12 mesh). More preferably, the particle size of the proppant particles may be from 210 microns to 840 microns (70 mesh to 20 mesh). The mesh size is based on the US mesh series in which the sieves are based on the fourth root of 2, that is to say, every fourth sieve represents a doubling of the particle size. Preferred proppant tight sieve distributions may be selected from 12/18 (1.68-1.00 mm), or 16/20 (1.19-0.84 mm), or 20/40 (0.84-0.42 mm), or 30/50 (0.589-0.297 mm), or even 40/70 (0.42-0.21 mm).

The proppant particle may comprise a multi-crystalline structure or a multi-crystalline core when coated; that is to say, the particle or its core contains a plurality of crystals.

The solid proppant may be in the form of single-component particles, compounded particles with various components, or coated particles.

### ‘Sacrificial’ Particles

In embodiments where a first injected fluid comprises which are permitted to embed into the softer shale stratum, the ‘sacrificial’ particles preferably comprises a material which is water-insoluble and is harder than the shale material in the underlying stratum. The ‘sacrificial’ particles may comprise any particulate material which is known to function as a proppant in oil and gas hydraulic fracturing applications as described above. The ‘sacrificial’ particles may be selected from the group consisting of sand (silica); and naturally-occurring material (e.g., made from nut shells and fruit pits).

### Single-Component Proppant Particles

The single-component particles when used in the injected fluid may consist of trona tailing particles, trona particles, or other alkali particles (preferably hydroxide particles; more preferably, alkali metal hydroxide particles or alkaline earth metal hydroxide particles).

### Compounded Proppant Particles

The compounded particles when used in the injected fluid may comprise a blend of two or more types of particles, preferably a blend of two types of particles containing different components. As an example, the compounded particles may comprise tailing sub-particles and other sub-particles comprising the alkali compound, both types of sub-particles being mixed and packed to form the compounded particles. The tailing sub-particles may have a particle size of 37 microns or lower (400 mesh or higher). The sub-particles comprising the alkali compound may be trona sub-particles and/or hydroxide sub-particles (preferably hydroxide sub-particles; more preferably, alkali metal or alkaline earth metal hydroxide sub-particles).

### Coated Proppant Particles

The coated particles when used in the injected fluid comprise a particulate core and a coating. The coating may be permeable or semi-permeable to a production solvent. The core material or a part thereof is preferably soluble in the production solvent. If the coating is also soluble in the production solvent, it is less soluble than the particulate core.

Where the coated proppant particles are to be transported by a water-based carrier fluid, the water solubility of the water-soluble coating should be sufficiently limited so that it will not substantially dissolve or degrade until the coated proppant is delivered to the desired strata interface (hereinafter “slow-water dissolving”). If an organic-based carrier fluid is used, the water solubility of the water-soluble coating can be greater.

The particulate core may comprise one or more alkali metal or alkaline earth metal inorganic compounds and/or water-insoluble trona tailings.

The particulate core may comprise alkali metal or alkaline earth metal hydroxide particles, trona particles, soda ash particles, trona tailings, or mixtures thereof.

The alkali metal or alkaline earth metal inorganic compound used in the particulate core may be selected from the group consisting of sodium carbonate, sodium bicarbonate, sodium sesquicarbonate, sodium hydroxide, calcium hydroxide, calcium carbonate, magnesium hydroxide, calcium carbonate, and combinations thereof.

For the solution mining of trona, the core of coated proppant particles preferably comprises trona or an alkali metal or alkaline earth metal hydroxide such as NaOH, Ca(OH)2, and/or Mg(OH)2.

In preferred embodiments, the particulate core consists of a trona particle, a soda ash particle, or an alkali metal or alkaline earth metal hydroxide particle.

The coating in the coated proppant particle may be applied to the particulate core as a coating layer. Such coating is especially applicable where the particulate core is porous. The coating is preferably applied to the circumference of the particulate core.

The amount of coating, when present, is typically from about 0.5 to about 10% by weight of the coated particles.

The material in the coating may be used as a slow-release and/or reactive material which dissolves and/or degrades the coating structure, thus increasing the coating permeability to solvent.

The coated particles may have a slow-dissolving coating (where dissolution is in relation to the production solvent) which would slowly dissolve the coating into the production solvent and permit the contact of the core material to the production solvent during mineral exploitation to permit dissolution of the core material, at least in part, in the production solvent.

The coated particles may have a reactive coating (where ‘reactivity’ in such coating is in relation to a reaction of a coating component with the production solvent or a component thereof). The reactive coating would degrade upon contact with the production solvent and would permit the contact of the core material to the production solvent during mineral exploitation and dissolution of the core material, at least in part, in the production solvent.

In general, the material in the coating can be described as any natural or synthetic material which is capable of forming a continuous coating, which will not dissolve under ambient surface conditions, but which will dissolve or at least degrade when in contact with a water-based production solvent inside the strata interface environment.

Thus, in preferred embodiments when a water-based production solvent is used, the coated particles in the solid proppant may comprise a water-soluble core and a slow-dissolving coating (lower water dissolution rate than core). The coating is slowly dissolved when in contact with at least a component of the aqueous production solvent used during mineral exploitation. The water dissolution rate of such coating should be lower than the water dissolution rate of the water-soluble core at the temperature and pressure conditions inside the interface gap.

The coated proppant particles can be formed from any water-soluble coating now or hereinafter known to function as a water-soluble coating for proppants used in oil and gas hydraulic fracturing application. These materials are thoroughly described, for example, in the above-noted documents, particularly in EP 0562879; U.S. Pat. No. 6,114,410; WO2005/003514; U.S. Pat. No. 7,490,667; US2005/0194141; and US2006/0175059, each being incorporated herein by reference.

For example, the coating of coated proppant particles may comprise, or consist of, a water-dissolving compound selected from the group consisting of polyalkylene oxides such as polyethylene oxide, polypropylene oxide; copolymers of ethylene oxide (EO) and propylene oxide (PO); polycaprolactones; graft copolymers of polyethylene oxide, polypropylene oxide and/or polycaprolactones; water reducible acrylics; water reducible phenoxy resins; polyesters; polyvinyl alcohols; polyvinyl acetates; graft copolymers of polyvinyl alcohols and polyvinyl acetates; polylactides; polyglycolic acid; polyglycolictacite acid; alkali metal or alkaline earth metal silicate polymer; vegetable polymers; collagen; other animal proteins; other low molecular weight proteins; or mixtures thereof.

The coating of coated proppant particles may comprise, or consist of, a water-dissolving polymer compound.

As well appreciated by those skilled in the art, the water solubility of such polymeric coating material (both in terms of the rate as well as the degree of polymer dissolution) can be controlled through mixing, grafting and copolymerization, as well as variations in molecular weight and cross-linking.

In this connection, Example 2 of US2006/0175059 describes an analytical test for determining the water solubility of various materials that can be used to form water-soluble coatings on proppants. This analytical test can be used to advantage here for selecting the particular water-soluble coatings to use in particular applications of this invention.

As indicated above, a slow-water dissolving material is preferably used to make the coated proppant intended to be delivered with a water-based carrier fluid. For this purpose it is desirable that, when subjected to the above analytical test, no more than 5% of the material dissolves when heated for 5 hours at 80° F. (26.7° C.), while no more than 40% of the material dissolves when heated for 4 hours at 150° F. (65.6° C.). Materials with water solubilities such that no more than 10% of the material dissolves when heated for 5 hours at 80° F. (26.7° C.), while no more than 30% of the material dissolves when heated for 4 hours at 150° F. (65.6° C.) are more desirable.

The amount of water-soluble coating to be used can vary widely and essentially any amount can be used. Normally, this amount will be sufficient to provide a water-soluble coating with a thickness of from about 1 to 60 microns, more typically from about 5 to 20 microns, or even from about 5 to 15 microns.

### Reinforcing Agent in Coated Particles

The coating of coated proppant particles may optionally contain a reinforcing agent. The reinforcing agent is preferably in the form of microparticles which are at least partially embedded in the water-soluble coating in a manner such that the microparticulate reinforcing agent is released from the proppant when the water-soluble coating dissolves or degrades.

The microparticulate reinforcing agents that may be used to make the \proppant used in the present invention are described, for example, in the above-noted documents, particularly in U.S. Pat. No. 5,422,183; U.S. Pat. No. 6,528,157; and US2005/0194141. In general, they can be described as any insoluble particulate material which is small in relation to the proppant particle substrate on which they are carried. In this context, “insoluble” means that they will not substantially dissolve when contacted with the carrier and formation fluids that will be encountered in use. Particular examples of materials from which the microparticulate reinforcing agent can be made include a material selected from the group consisting of trona fines, silica flour, talc, sodium carbonate, sodium sulfate, calcium carbonate, calcium sulfate, ceramic microspheres, and mixtures thereof.

In the present invention, trona tailings may be used as microparticulate reinforcing agent. Trona tailings used as microparticulate reinforcing agent would have preferably a particle size of less than 74 microns (passing through a 200 mesh sieve); more preferably a particle size of less than 44 microns (passing through a 325 mesh sieve) or even a particle size of less than 37 microns (passing through a 400 mesh sieve).

The particle size of the microparticulate reinforcing agent is 25% or less of the particle size of the proppant core on which it is carried. More typically, the microparticulate reinforcing agent will have a particle size which is 10% or less or even 5% or less of the particle size of the proppant particulate core.

These microparticulate reinforcing agents can have any shape including spherical, toroidal, platelets, shavings, flakes, ribbons, rods, strips, etc. Microparticulate reinforcing agents having a generally uniform shape (i.e. aspect ratio of 2 or less) will generally have a particle size of about 300 mesh or finer (approximately 40μ or finer). Microparticulate reinforcing agents of this type having particle sizes on the order of 1 to 25 microns (from 40 to 20 mesh) are particularly interesting. Elongated microparticulate reinforcing agents (i.e., aspect ratio of more than 2) will generally have a length of about 150 microns or less, more typically about 100 microns or less or even 50 microns or less.

As indicated above, the thickness of the water-soluble coating of the proppant particle can be as little as 3 microns. This may be significantly less than the particle size of the microparticulate reinforcing agent being used, which means that these reinforcing agent microparticles may not be completely embedded in the water-soluble coating. Rather in some instances, remote portions of these reinforcing agent microparticles may not be embedded in the water-soluble coatings at all. In other instances, the thickness of the water-soluble coating may vary significantly from location to location to accommodate reinforcing agent microparticles of different thicknesses. All of these variations are possible, so long as enough water-soluble coating is used to substantially bind the microparticulate reinforcing agent to the proppant particle substrate, that is to say, so long as a substantial amount of the reinforcing agent microparticles remain bound to the product proppant particles until they are delivered to the desired interface location.

The amount of microparticulate reinforcing agent that can be used in making the solid proppant can vary widely and essentially any amount can be used. From a practical standpoint, enough microparticulate reinforcing agent should be used to provide a noticeable increase in the crush strength of a proppant pack formed from the proppant particles but no so much that no additional benefit is realized. Normally, this means that the microparticulate reinforcing agents will be present in amounts of about 1 to 50%, more typically about 5 to 45 wt. %, based on the total weight of the water-soluble coating and microparticulate reinforcing agent combination.

### Optional Agent in Proppant

In some embodiments, it may be desirable to introduce a treatment agent in the strata interface gap. Such treatment agent may facilitate the dissolution of the mineral and/or may react with at least one component of the mineral to form a compound with an increased solubility of this mineral component in the production solvent which is used in the subsequent solution mining exploitation phase.

It is thus envisioned in the present invention that in some embodiments, the proppant includes such treatment agent. This treatment agent would be preferably released from the proppant over a sustained period of time thus not requiring the continuous attention of solution mine operators over prolonged periods.

For that reason, such treatment agent is preferably incorporated in the core of coated proppant particles.

In such instances, these coated particles may comprise a slow-dissolving coating which would permit the slow release of the treatment agent during mineral exploitation; or these coated particles may comprise a reactive coating (where ‘reactivity’ of such coating is in relation to a component in the production solvent) which would degrade the coating permitting the slow release of the treatment agent during mineral exploitation.

In preferred embodiments, such treatment agent is a strong alkali inorganic compound with a pKb of 3 of less (pKa of more than 11), such as sodium hydroxide (pKb of 0.2), potassium hydroxide (pKb=0.5) and/or calcium hydroxide (pKb=2.43 and 1.4).

One of the advantages of the use of a strong alkali inorganic core enveloped in a low-water soluble coating in a coated proppant particle according to the present invention is to the release of the strong alkali inorganic compound in particular NaOH or Ca(OH)2 during dissolution of trona. As explained previously, the incongruent solubilities of sodium carbonate and sodium bicarbonate present as a double-salt in trona can cause sodium bicarbonate “blinding” during solution mining. Sodium bicarbonate, which has dissolved in the mining solution tends to redeposit out of the solution onto the exposed face of the trona ore as the carbonate saturation in the solution increases, thus clogging the dissolving face and “blinding” its carbonate values from further dissolution and recovery. Applicants thus provide a remedy to this issue, by using the in situ release of NaOH or Ca(OH)2 from the proppant core inside the interface gap and later inside the formed cavity during the trona dissolution step. This release of NaOH or Ca(OH)2 from the proppant which is lodged inside the interface gap and likely also deposited at the bottom of the formed cavity will permit the conversion of sodium bicarbonate with hydroxide to form the more-soluble sodium carbonate thereby preventing incongruent dissolution and bicarbonate blinding in the mine.

In some embodiments, it may be desirable to introduce a traceable agent in the proppant material. The traceable agent is generally a chemical marker with which the proppant particles are tagged. Such chemical marker may be used to determine the location of proppant which helps determine the width of the propped interface gap and proppant placement within the interface gap, and also may help determine the source of proppant flowback when hydraulic pressure is reduced at a value lower than what is necessary to lift the overburden at the interface. Such traceable agent is generally non-radioactive.

### Mineral Dissolution and Brine Production

In preferred embodiments, trona dissolution by a production solvent and brine production follow the lithological displacement and placement of proppant in the interface gap once the hydraulic pressure has reached the desired lifting pressure.

The dissolution step may comprise stopping injection of the fluid, releasing the hydraulic pressure to allow flowback of carrier liquid, and injecting a production solvent (an aqueous fluid) from the injection well into the interface gap left propped open by the proppant to initiate dissolution of mineral from free-surfaces in the propped interface gap.

Or the dissolution step may comprise reducing the fluid flow rate to maintain a desired hydraulic pressure during mineral dissolution, this option being preferred when the carrier liquid in the injected fluid already comprises water suitable for dissolving trona. It is expected that there will be fluid loss to the formation as it is not liquid-tight. This minimal flow of the fluid or production solvent may be necessary to compensate for the bleed-off of liquid to the formation.

The production solvent (water or aqueous solution) remains inside the propped gap and by dissolution of mineral with which it comes in contact, the solvent gets impregnated with dissolved mineral to form a brine, and the interface gap gets enlarged into a mineral cavity.

The proppant comprising slow-water dissolving particles or coated particles which comprises a slow-water dissolving coating and/or a reactive coating slowly start dissolving in the production solvent and/or degrades when in contact with the production solvent.

At least a portion of this brine may be extracted from the mineral cavity to the surface. Once the brine achieves a desired target mineral content (e.g., a minimum TA content of 8% or preferably at least 15% TA content for trona dissolution), the extracted brine may be used for further processing to form one or more products.

Alternatively, the dissolution step which follows the injection step once the hydraulic pressure has reached the desired lifting pressure, may be carried out by continuously injecting a production solvent into the interface gap to dissolve trona with which it comes in contact, so that the solvent gets impregnated with dissolved trona to form a brine, and the gap gets enlarged into a cavity.

At least a portion of this brine may be extracted continuously from the trona cavity in such a way as to maintain the desired pressure at the gap. The extracted brine may be recycled in part and re-injected into the cavity for additional enrichment in sodium (bi)carbonate.

Brine production may be carried out via one or more wells which may be vertical or directionally drilled. The same well used for injection may be used for production if the solution mining is operated in discontinuous mode.

The solution mining method of the present invention may further comprise forming another well which serves as a production well. This production well intersects the strata interface, may be fully cased and cemented but perforated at that interface to allow fluid communication between the trona cavity and the inside of this well.

The dissolution and production steps may be carried out in continuous mode, in which the solvent is continuously injected, trona gets dissolved while the solvent flows through the trona cavity, and at least a portion of the brine is continuously extracted.

Or the dissolution and production steps may be carried out in discontinuous mode, in which solvent injection and brine production are not continuous, and the dissolution and production steps may not be carried out simultaneously.

In preferred embodiments, the method further comprises, during trona dissolution from trona free-surface, dissolving the proppant or at least a portion thereof when in contact with injected production solvent.

In other preferred embodiments, the method further comprises, during trona dissolution from trona free-surface, reacting at least a portion of the proppant with at least one component of the injected production solvent.

### Manufacturing Process for Making One or More Sodium-Based Products

In another aspect, the present invention also relates to a manufacturing process for making one or more sodium-based products from an evaporite mineral stratum comprising a water-soluble mineral selected from the group consisting of trona, nahcolite, wegscheiderite, and combinations thereof, said process comprising:
carrying out any aspect or any embodiment of the method according to the present invention to solution mine the evaporite mineral stratum and to dissolve mineral from the main mineral free-surface created at the strata interface into a solvent to obtain a brine comprising sodium carbonate and/or bicarbonate, and
passing at least a portion of said brine through one or more units selected from the group consisting a crystallizer, a reactor, and an electrodialysis unit, to form at least one sodium-based product.

In trona solution mining, the brine extracted to the surface may be used to recover alkali values.

Examples of suitable recovery of sodium values such as soda ash, sodium sesquicarbonate, sodium carbonate decahydrate, sodium bicarbonate, and/or any other sodium-based chemicals from a solution-mined brine can be found in the disclosures of U.S. Pat. No. 3,119,655 by Frint et al; U.S. Pat. No. 3,050,290 by Caldwell et al; U.S. Pat. No. 3,361,540 by Peverley et al; U.S. Pat. No. 5,262,134 by Frint et al.; and U.S. Pat. No. 7,507,388 by Ceylan et al., and these disclosures are thus incorporated by reference in the present application.

Another example of recovery of sodium values is the production of sodium hydroxide from a solution-mined brine. U.S. Pat. No. 4,652,054 to Copenhafer et al. discloses a solution mining process of a subterranean trona ore deposit with electrodialytically-prepared aqueous sodium hydroxide in a three zone cell in which soda ash is recovered from the withdrawn mining solution. U.S. Pat. No. 4,498,706 to Ilardi et al. discloses the use of electrodialysis unit co-products, hydrogen chloride and sodium hydroxide, as separate aqueous solvents in an integrated solution mining process for recovering soda ash. The electrodialytically-produced aqueous sodium hydroxide is utilized as the primary solution mining solvent and the co-produced aqueous hydrogen chloride is used to solution-mine NaCl-contaminated ore deposits to recover a brine feed for the electrodialysis unit operation. These patents are hereby incorporated by reference for their teachings concerning solution mining with an aqueous solution of an alkali, such as sodium hydroxide and concerning the making of a sodium hydroxide-containing aqueous solvent via electrodialysis.

The manufacturing process may comprise: passing at least a portion of the brine comprising sodium carbonate and/or bicarbonate:
through a sodium sesquicarbonate crystallizer under crystallization promoting conditions to form sodium sesquicarbonate crystals;
through a sodium carbonate monohydrate crystallizer under crystallization promoting conditions to form sodium carbonate monohydrate crystals;
through a sodium carbonate crystallizer under crystallization promoting conditions to form anhydrous sodium carbonate crystals;
through a sodium carbonate hydrate crystallizer under crystallization promoting conditions to form crystals of sodium carbonate decahydrate or heptahydrate;
to a sodium sulfite plant where sodium carbonate is reacted with sulfur dioxide to form a sodium sulfite-containing stream which is fed through a sodium sulfite crystallizer under crystallization promoting conditions suitable to form sodium sulfite crystals; and/or
through a sodium bicarbonate reactor/crystallizer under crystallization promoting conditions comprising passing carbon dioxide to form sodium bicarbonate crystals.

In any embodiment of the present invention, the process may further include passing at least a portion of the brine through one or more electrodialysis units to form a sodium hydroxide-containing solution. This sodium hydroxide-containing solution may provide at least a part of the injected fluid to be injected into the gap for the lifting step and/or may provide at least a part of the production solvent to be injected into the cavity for the dissolution step.

In any embodiment of the present invention, the process may further comprise pre-treating and/or purifying by removal of impurities and/or enriching with a solid mineral the extracted brine or a portion thereof which is used before making such product.

The process may comprise pre-treating a portion of the extracted brine when such brine comprises sodium bicarbonate (preferably more than 3.5 wt %) before it is used to recover alkali values. The pre-treating may be carried out on at least a part of the extracted brine prior to being passed to an electrodialysis unit, a crystallizer, and/or a reactor.

The process may comprise pre-treating a portion of the extracted brine when such brine comprises sodium bicarbonate (preferably more than 3.5 wt %) before it is recycled to the cavity for further mineral dissolution.

The pre-treating in these instances may convert some of the sodium bicarbonate to sodium carbonate to achieve a sodium bicarbonate concentration in the pretreated brine below 3.5% by weight, preferably below 2% by weight, more preferably below 1% by weight, before being further subjected to a crystallization step or before being recycled at least in part to the cavity. The pretreatment of the brine may comprise contacting at least a portion of said brine with steam, and/or the pretreatment of the brine may comprise reacting the sodium bicarbonate in the brine with sodium hydroxide or another base such as calcium hydroxide.

The pre-treating may additionally or alternatively include adjusting the temperature and/or pressure of at least a portion of the extracted brine before recovering alkali values therefrom and/or before recycling into the cavity.

In some embodiments, the process may further comprise removing at least a portion of impurities from at least a portion of the brine which is used to recover valuable products (such as alkali values) to purify the brine prior to being passed to a process unit (such as electrodialysis unit, crystallizer and/or reactor). Such removal may include removal of water-soluble and/or colloidal organics for example via carbon adsorption and/or filtration.

In embodiments for trona solution mining, the process may further purifying at least a portion of the brine which is fed to a crystallizer and/or reactor to make sodium product(s). The brine may indeed contain insoluble material, some of which may have precipitated after the brine is extracted to the surface and/or may have been carried from the underground cavity to above ground such as mineral insolubles and/or proppant water-insoluble sub-particles (such as fines). Such purification step preferably comprises removing insoluble material. Such removal may include sedimentation and/or filtration.

In some embodiments, the process may further comprise adding solid mineral (such as mechanically-mined solid virgin trona or calcined trona) to at least a portion of the extracted brine which is not recycled to the cavity prior to being passed to a process unit (such as crystallizer and/or reactor) to make one or more valuable mineral-derived products (e.g., sodium-based products). The addition of solid mineral to the solution-mined brine may be carried out on at least a part of the brine after but preferably prior to the pre-treatment step as described earlier.

For brines obtained from solution mining of trona, the process may include, after extracting at least a portion of the brine to the surface, at least one of the following steps:
adding solid virgin trona and/or calcined trona to the extracted brine portion to increase the content in total sodium carbonate and to form an enriched brine containing at least 20% by weight of sodium carbonate;
optionally, pre-treating such enriched brine; and
recovering at least one alkali value, for example passing such enriched brine to an electrodialysis unit, a crystallizer, and/or a reactor in which at least one sodium-based product is produced.

### Sodium-Based Product Obtained by the Manufacturing Process

The present invention further relates to a sodium-based product obtained by the manufacturing process according to the present invention, said product being selected from the group consisting of sodium sesquicarbonate, sodium carbonate monohydrate, sodium carbonate decahydrate, sodium carbonate heptahydrate, anhydrous sodium carbonate, sodium bicarbonate, sodium sulfite, sodium bisulfite, sodium hydroxide, and other derivatives.

It should be understood that any description, even though described in relation to a specific embodiment or drawing, is applicable to and interchangeable with other embodiments of the present invention.

The discussion of a reference in the Background is not an admission that it is prior art to the present invention, especially any reference that may have a publication date after the priority date of this application.

Numeric ranges recited herein are inclusive of the numbers defining the range and include and are supportive of each integer within the defined range.

The section headings used herein are for organizational purposes only and are not to be construed as limiting the subject matter described.

All documents, or portions of documents, cited in this application, including but not limited to patents, patent applications, articles, books, and treatises, are hereby expressly incorporated by reference in their entirety for any purpose, to the extent that they provide exemplary, procedural or other details supplementary to those set forth herein.

Should the disclosure of any of the patents, patent applications, and publications that are incorporated herein by reference conflict with the present specification to the extent that it might render a term unclear, the present specification shall take precedence.

While preferred embodiments of this invention have been shown and described, modifications thereof can be made by one skilled in the art without departing from the spirit or teaching of this invention. The embodiments described herein are exemplary only and are not limiting. Many variations and modifications of systems and methods are possible and are within the scope of the invention.

Each and every claim is incorporated into the specification as an embodiment of the present invention. Thus, the claims are a further description and are an addition to the preferred embodiments of the present invention.

Accordingly, the scope of protection is not limited by the description set out above, but is only limited by the claims which follow, that scope including all equivalents of the subject matter of the claims.

What we claim is:

1. In an underground formation containing an evaporite mineral stratum containing trona, nahcolite, wegscheiderite, and combinations thereof, said stratum lying immediately above a shale stratum, said formation comprising a defined weak parting interface between the two strata and above which is defined an overburden up to the ground surface,
a method for solution mining of said evaporite mineral stratum, comprising a lithological displacement of the evaporite mineral stratum, comprising:
applying a hydraulic pressure which is greater than the overburden pressure at the interface to lithologically displace the overburden at the strata interface, thereby forming an interface gap and creating a mineral free-surface; and
injecting a fluid comprising a solid proppant material in said interface gap to place said solid proppant material inside said interface gap to keep said interface gap open.

2. The method according to claim 1, wherein the injection of said fluid comprising said solid proppant material provides said hydraulic pressure which is greater than the overburden pressure to form said interface gap and place simultaneously said solid proppant material inside said gap.

3. The method according to claim 1, wherein the injection of said fluid comprising said solid proppant material is performed after said interface gap is created by the application of said hydraulic pressure which is greater than the overburden pressure.

4. The method according to claim 1, wherein said lifting hydraulic pressure applied is characterized by a fracture gradient between 0.9 psi/ft (20.4 kPa/m) and 1.5 psi/ft (34 kPa/m).

5. The method according to claim 1, wherein said solid proppant material comprises water-insoluble tailings, particles comprising an alkali compound, or combinations thereof, wherein said alkali compound is selected from the group consisting of sodium carbonate, sodium bicarbonate, sodium sesquicarbonate, sodium hydroxide, calcium hydroxide, magnesium hydroxide, ammonium hydroxide, calcium carbonate, and combinations thereof.

7. The method according to claim 1, wherein the solid proppant material comprises tailings.

8. The method according to claim 7, wherein said tailings in the solid proppant material have an average particles size of 74 microns or more.

9. The method according to claim 1, wherein said solid proppant material comprises coated particles, said coated particles including a core comprising a water-soluble material and a coating comprising a less-water soluble material.

10. The method according to claim 9, wherein said water-soluble material in the core is soda ash, trona, an alkali metal hydroxide, or an alkaline earth metal hydroxide, and wherein said less-water soluble material in the coating comprises a slow-water dissolving polymeric material.

11. The method according to claim 1, wherein said fluid comprising said solid proppant material comprises water or an aqueous solution comprising sodium carbonate, sodium bicarbonate, sodium hydroxide, or combinations thereof.

12. The method according to claim 1, wherein said solid proppant material comprises coated particles, said coated particles including a core of sodium hydroxide, a core of trona, or a core of soda ash.

13. The method according to claim 1, wherein said application of said hydraulic pressure which is greater than the overburden pressure also forms a shale face in the interface gap; and wherein the method further comprises:
injecting a first fluid comprising a solid sacrificial material in said interface gap to place said solid sacrificial material inside said interface gap and permit at least some of said solid sacrificial material to embed into the shale face of the interface gap to create a harder surface on the shale stratum inside the interface gap; and
then, injecting a second fluid comprising said solid proppant material in said interface gap to place said solid proppant material inside said interface gap on top of said harder surface.

14. The method according to claim 13, wherein said solid sacrificial material consists of water-insoluble particles; and wherein said solid sacrificial material consists of particles which are harder than said shale stratum but which are as hard or less hard than said evaporite mineral to be mined to prevent said solid sacrificial material to embed itself into said mineral free-surface.

15. The method according to claim 1, further comprising:
injecting a production solvent into said interface gap being kept open by said solid proppant material to dissolve said evaporite mineral from the created mineral free-surface to form a brine, thereby enlarging said interface gap to form a mineral cavity; and
dissolving at least a portion of said solid proppant material when in contact with said injected production solvent.

16. The method according to claim 1, further comprising:
injecting a production solvent into said interface gap being kept open by said solid proppant material to dissolve said evaporite mineral from the created mineral free-surface to form a brine, thereby enlarging said interface gap to form a mineral cavity; and
reacting at least a portion of said proppant material with at least one component of said injected production solvent.

17. A solid proppant material for lithological displacement of trona stratum from a shale stratum, comprising water-insoluble tailings obtained from a mineral refining processing plant; trona particles; soda ash particles; particles of one or more hydroxide compounds; or combinations thereof.

18. The solid proppant material according to claim 17, comprising coated particles with a water-soluble particulate core and a slow-water dissolving coating, said water-soluble particulate core consisting of trona particles, soda ash particles, or particles of one or more hydroxide compounds, said coating comprising a slow-water dissolving polymeric material.

19. The solid proppant material according to claim 17, comprising coated particles with a water-soluble particulate core and a slow-water dissolving coating, said water-soluble particulate core comprising an alkali compound, said coating comprising a slow-water dissolving polymeric material in which water-insoluble trona tailings of size less than 74 microns are used as microparticulate reinforcing agent.

20. A fluid comprising said solid proppant material of claim 17 and further comprising a liquid carrier in which said solid proppant material is suspended.
